(19) United States
(12) Patent Application Publication
(10) Pub. No.: US 2025/0357098 A1
(43) Pub. Date: Nov. 20, 2025

(54) AUTOMATED CALIBRATION OF SECONDARY ION MASS SPECTROMETRY SYSTEMS

(71) Applicant: Applied Materials, Inc., Santa Clara, CA (US)

(72) Inventors: Ming Hong Yang, Campbell, CA (US); Arun Ramaswamy Srivatsa, San Jose, CA (US)

(21) Appl. No.: 19/200,847

(22) Filed: May 7, 2025

Related U.S. Application Data
(60) Provisional application No. 63/648,753, filed on May 17, 2024.

(51) Int. Cl. H01J 49/02; H01J 49/00

(52) U.S. Cl. CPC H01J 49/025; H01J 49/0009

(57) ABSTRACT

A method can include setting a coil current of a secondary ion mass spectrometry (SIMS) system to an initial coil current setting, determining a first measurement of a first sample at the initial coil current setting, automatically varying the coil current to one or more additional coil current settings that have up to a threshold delta from the initial coil current setting, determining one or more additional measurements of the first sample at the one or more additional coil current settings, identifying, from the one or more additional measurements, a maximal measurement that has a maximal value, and calibrating the SIMS system based on setting the coil current to a target coil current setting corresponding to the maximal measurement.

### CROSS-REFERENCE TO RELATED APPLICATION(S)

The present application claims priority to U.S. Provisional Patent Application No. 63/648,753, filed on May 17, 2024 and entitled “AUTOMATED CALIBRATION OF SECONDARY ION MASS SPECTROMETRY SYSTEMS”, the entire contents of which are hereby incorporated by reference herein.

### TECHNICAL FIELD

Embodiments of the present disclosure relate generally to mass spectrometry, and in particular to automated calibration of secondary ion mass spectrometry (SIMS) systems.

### BACKGROUND

Secondary ion mass spectrometry (SIMS) is a technique used to analyze the composition of layers (e.g., films) as a function of depth by sputtering the surface of the specimen with a focused primary ion beam and collecting and analyzing ejected sputtered particles including secondary ions. The ion species emanating from the layer can be used to analyze the composition of the layer, and ion intensity can be used to estimate thickness. A SIMS system can be used for a variety of different applications for examining films and multilayers of different compositions. A recipe defining a set of instructions for running the SIMS system can be optimized for a particular application. Depending on the elements to be examined, a recipe may require optimization for different mass spectrometer settings to identify different species.

A SIMS system can include multiple ion detectors (“detectors”) positioned to measure ion counts (“counts”) of respective ion species output a magnetic sector of the SIMS system. When the SIMS system is set correctly, the counts measured at each detector can be maximized for a particular ion species. A key to the robustness of this technique is the ability of the settings of the mass spectrometer to be reproducible for optimal detector locations for respective ion species. For example, reproducibility can be dictated by the ability of the SIMS system to accurately reproduce the same magnetic field strength, which is what determines the trajectory of the ion species toward the detectors.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In some aspects, a method is provided. The method includes setting a coil current of a secondary ion mass spectrometry (SIMS) system to an initial coil current setting, determining a first measurement of a first sample at the initial coil current setting, automatically varying the coil current to one or more additional coil current settings that have up to a threshold delta from the initial coil current setting, determining one or more additional measurements of the first sample at the one or more additional coil current settings, identifying, from the one or more additional measurements, a maximal measurement that has a maximal value, and calibrating the SIMS system based on setting the coil current to a target coil current setting corresponding to the maximal measurement.

In some aspects, a method is provided. The method includes initializing calibration of a secondary ion mass spectrometry (SIMS) system, setting an initial coil current, identifying, using the initial coil current, a target coil current for generating a target magnetic field, and calibrating the SIMS system based at least in part on the target coil current.

In some aspects, a system is provided. The system includes a memory and a processing device, operatively coupled with the memory, to initialize calibration of a secondary ion mass spectrometry (SIMS) system, set an initial coil current, identify, using the initial coil current, a target coil current for generating a target magnetic field, and calibrate the SIMS system based at least in part on the target coil current.

### BRIEF DESCRIPTION OF THE DRAWINGS

Aspects and implementations of the present disclosure will be understood more fully from the detailed description given below and from the accompanying drawings, which are intended to illustrate aspects and implementations by way of example and not limitation.

FIG. 1 is a diagram of an example secondary ion mass spectrometry (SIMS) system, according to some embodiments of the present disclosure.

FIG. 2 is a schematic diagram of an example multi-detector mass spectrometer, according to some embodiments of the present disclosure.

FIG. 3 is a graph illustrating an example mass spectrum using a set of detectors, according to some embodiments of the present disclosure.

FIGS. 4A-4B are flow diagrams of example methods of implementing automated calibration of a secondary ion mass spectrometry (SIMS) system, in accordance with one embodiment of the present disclosure.

FIG. 5 illustrates an embodiment of a diagrammatic representation of a computing device associated with a substrate manufacturing system, in according to some embodiments of the present disclosure.

### DETAILED DESCRIPTION

Embodiments described herein relate to automated in-line secondary ion mass spectrometry (SIMS) calibration. SIMS can involve bombarding a sample surface with a focused primary ion beam. The impacting ions create a collisional cascade in the top layers of the sample surface, resulting in the ejection of sputtered particles, which can include secondary ions. The sputtered particles may be from one or more top atomic layers of the sample, and may be produced from within a few nanometers (nm) of a primary ion's impact location. In SIMS, the secondary ions are directed into a mass analyzer to gain information about the nature of species present at the surface of the sample and/or a composition of the surface. Analyses can be made at one or more locations of a sample. In some instances, a profile map of a surface may be generated by rastering the ion beam or directly imaging the sample by secondary ions (e.g., performing ion microscopy).

An automated in-line SIMS system can automatically and accurately separate ion species by mass and measure intensity (detector counts, or counts) by mass number. This separation of ion species by mass can be done using a magnetic field. The magnetic field can be generated by current flowing through a coil (“coil current”), in which the magnitude of the magnetic field depends in part on the magnitude of the coil current. For example, for a fixed magnetic field, a specific ion species can be detected by placing the detector at a location determined in accordance with the charge (e) to mass (M) ratio (e/m) of the ion species. Accordingly, different ion species can be detected using respective detectors located at respective locations.

One challenge to using automated in-line SIMS systems is mass calibration. For example, the magnetic field strength can be controlled by the coil current which is set by the recipe. The phenomenon of magnetic hysteresis can cause inaccurate mass calibration when settings are adjusted between measurements of different samples. Magnetic hysteresis can cause small differences in the actual field strength even when the same coil current is used. Thus, for the same measurement recipe, there can be differences in intensity at a detector caused by small offsets in the trajectory of the ions. These differences in intensity can negatively affect the repeatability of the measurement on different samples or even on a same sample, causing deviations from a maximum intensity at detector, and resulting in measurement errors. Accordingly, compensating for magnetic hysteresis to ensure that the trajectory of the ions remains substantially unchanged between measurements can reduce or eliminate such measurement errors.

Some solutions to compensate for magnetic hysteresis of a SIMS systems involve manually calibrating the SIMS system before a production run each time when a change in the polarity of the magnetic field is needed. Moreover, the positions of the detectors can be manually adjusted about their designated locations to maximize detector counts. Manual calibration techniques to compensate for magnetic hysteresis can rely on constant operator intervention and manual tuning. Accordingly, manual calibration techniques to compensate for magnetic hysteresis are not viable solutions for implementing an automated SIMS system (e.g., fully automated SIMS system).

Embodiments described herein address these and other challenges by implementing automated calibration of SIMS systems to compensate for magnetic hysteresis, such as for in-line SIMS systems. An automated calibration method described herein can more efficiently compensate for magnetic hysteresis as compared to manual calibration techniques. An automated calibration method described herein can be implemented by a recipe to be executed automatically by the SIMS system. Such a calibration procedure may be performed, for example, between measurements of a particular type of sample once a measurement recipe (e.g., particular SIMS settings) for measuring that type of sample has been generated. The automatic calibration procedure may be used to ensure repeatability of measurements of the same type of sample using the measurement recipe for that type of sample by eliminating hysteresis that can occur between measurements of samples.

An automated calibration method described herein can at least partially compensate for magnetic hysteresis by automated repeated switching of magnetic polarity settings. More specifically, magnetic polarity settings can be switched by changing the coil current direction multiple times. The repeated switching of magnetic polarity settings can reduce the difference between the actual magnetic field achieved by the SIMS device and the target magnetic field that is specified for a measurement (e.g., in a measurement recipe), which can reduce the effect of magnetic hysteresis. However, there may be a residual difference between the actual magnetic field and the target magnetic field (e.g., some remaining hysteresis).

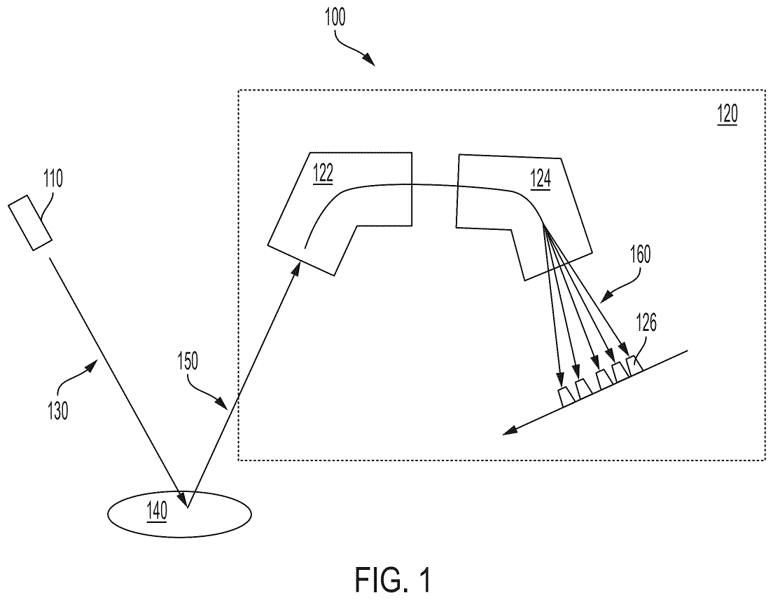

To correct for this residual difference, an automated calibration method described herein can tune a previous coil current used to generate the magnetic field with respect to a known species. It can be observed that a magnetic field has a one-to-one relationship with the flight path of an ion species in the magnetic field. By fixing the position of a detector for a matrix species with a strong signal (e.g., silicon (Si)), the flight path and thus magnetic field can be determined. Tuning the previous coil current can include adjusting the previous coil current about a small current differential to identify a target coil current that results in the maximal number of counts. Because the magnetic field is very close to the previously coil current, a less than one percent change in coil current may be sufficient to identify the target coil current that maximizes the number of counts (e.g., any magnetic hysteresis associated with the adjustment can be neglected). The target coil current resulting in the maximal number of counts may correspond to the correct coil current for generating a target magnetic field. Since the number of counts (and thus intensity) have been maximized using the automated calibration method, the effect of the magnetic hysteresis is automatically corrected without manually adjusting the detector position. For example, the previous coil current can be defined as I₀. To find the target coil current Iₘₐₓ, I₀ can be adjusted to maximize a known peak (e.g., strong peak) near the middle of the range of the mass spectrometer (e.g., by maximizing the counts for a known species). I₀ can be adjusted within 2d range [I₀−d, I₀+d] to identify Iₘₐₓ, where d is a value in which any magnetic hysteresis associated with the adjustment can be neglected. Further details regarding implementing the automated calibration method will be described herein below with reference to FIGS. 1-5.

Embodiments described herein can provide a number of technical benefits. For example, automated calibration method described herein can compensate for magnetic hysteresis in SIMS systems without the use of manual calibration methods. Such automated calibration can enable the implementation of fully automated in-line SIMS systems, as compared to partially automated or manually controlled in-line SIMS systems.

FIG. 1 is a diagram of an example secondary ion mass spectrometry (SIMS) system 100, according to some embodiments of the present disclosure. As shown, the SIMS system 100 can include an ion source 110 and a secondary ion column 120. The secondary ion column 120 can include an electrostatic analyzer 122, a magnetic sector 124, and a set of ion detectors (“detectors”), including detector 126. The set of detectors can be referred to as a detector array. The set of detectors are located at the end of the secondary ion column 120 along an approximately straight line. Each detector of the set of detectors (e.g., detector 126) can be moved individually along a direction defined by the approximately straight line for a fixed length.

As shown in FIG. 1, the ion source 110 can generate a beam of primary ions (“primary ion beam”) 130 directed toward a sample 140. The primary ion beam 130 can sputter particles from the surface of the sample 140, such as ions, electrons, neutral particles, etc. Secondary ions 150 of the sputtered particles are then collected and analyzed in the secondary ion column 122. The electrostatic analyzer 122 can permit ions of the secondary ions 150 with a certain energy (e.g., a few kilovolts) to pass through with an energy bandwidth of a few volts. The ions of the secondary ions 150 can be spatially separated within the magnetic sector 124 into respective ion trajectories by a magnetic field according to their charge (e) to mass (M) ratio (e/m). The ions of the secondary ions 150 can be measured (e.g., simultaneously or near simultaneously) by respective detectors of the set of detectors at their corresponding locations. For example, secondary ions of a secondary ion trajectory 160 can be measured by detector 126. The total number of species, which can be measured in a single run, depends on the number of detectors of the set of detectors.

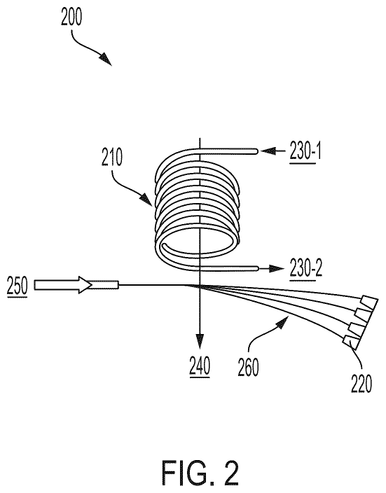

FIG. 2 is a schematic diagram of an example multi-detector mass spectrometer 200, according to some embodiments of the present disclosure. For example, the multi-detector mass spectrometer 200 can be implemented within a secondary ion column, such as the secondary ion column 120 of FIG. 1.

As shown, the multi-detector mass spectrometer 200 includes a coil 210 and a set of detectors including detector 220 (e.g., similar to detector 126 of FIG. 1). A coil current enters the coil 210 at a first end 230-1 and exits the coil 210 at a second end 230-2. The magnitude of the coil current, as well as the number of turns of the coil, defines the magnitude of a magnetic field 240 generated by the coil 210 (e.g., in accordance with Faraday's law). Accordingly, the magnitude of the magnetic field 240 can be adjusted by adjusting the magnitude of the coil current flowing through the coil 210 (or by changing the geometry of the coil 210).

As further shown, secondary ions 250 are sent through the magnetic field 240. The trajectories of the secondary ions 250 can be deflected by the magnetic field 240. The deflection of the trajectory of each secondary ion of the secondary ions 250 can depend on the e/m ratio of the secondary ion. The deflection separates the secondary ions 250 into respective secondary ion paths (e.g., secondary ion path 260), where each secondary ion path includes secondary ions having an approximately similar e/m ratio. Each detector of a set of detectors is positioned to receive secondary ions from a respective secondary ion path, such as the detector 220 positioned to receive secondary ions from the secondary ion path 260. Each detector is configured to detect a number of ion counts (“counts”) of ions that are received by the detector.

The distribution of counts over a particular distance can be referred to as a mass spectrum. There is a direct relationship between atomic mass and distance, since a heavier ion is easier to deflect. The atomic mass number can be identified by the composition of a material and the primary beam ions used for sputtering. Illustratively, when sputtering a boron (B)-doped silicon (Si) sample using oxygen-18 (¹⁸O) ions, high counts can be expected for the following species: boron-10 (¹⁰B), boron-11 (¹¹B), ¹⁸O, silicon-28 (²⁸Si), silicon-29 (²⁹Si), and silicon-30 (³⁰Si). The major species can then be identified from the isotopic abundance. A mass calibration curve can be obtained by graphing the position X versus mass M. For example, for a uniform magnetic field which can be employed by a SIMS system, the mass calibration curve can be approximated by X=a\sqrt{M}+b, where a and b are calibration constants.

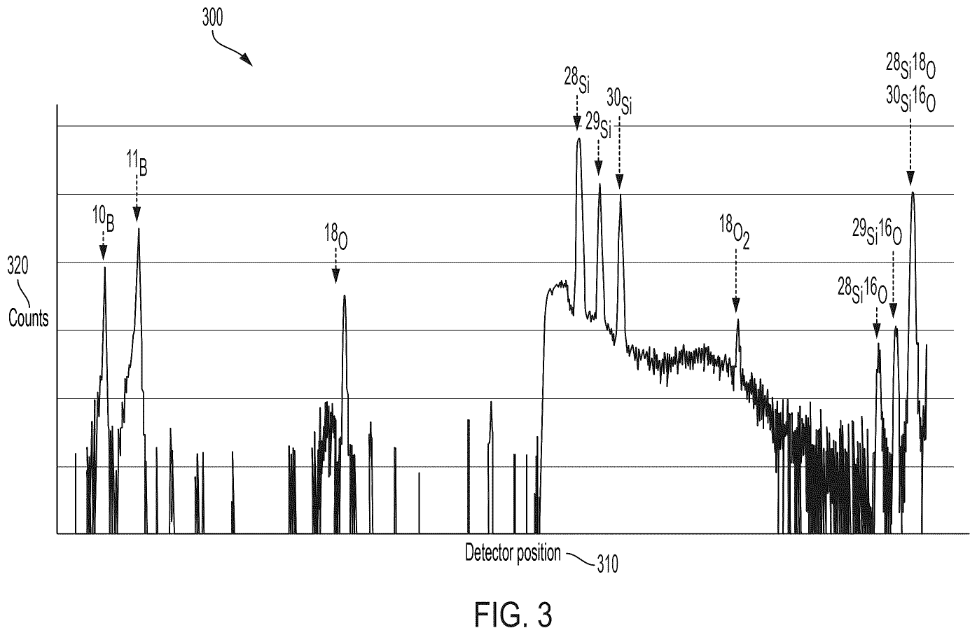

The dimension of the active area for a detector (e.g., detector 220) can range in size from about 0.5 millimeter (mm) to about 1 mm in size and the minimum distance between adjacent detectors of the set of detectors can be at least 10 mm depending on the geometry of a specific design. The actual mass resolution can depend on multiple factors, such as the entrance slit, exit slit, and ion beam alignment. The accuracy of the measurement can also depend on detector location precision. The minimum mass separation for two species to be monitored simultaneously can determined by the minimum separation between the two adjacent detectors and the mass calibration curve (e.g., X=a\sqrt{M}+b). An example of the mass spectrum obtained using different detectors at different mass ranges will now be described below with reference to FIG. 3.

FIG. 3 is a graph 300 illustrating an example mass spectrum using a set of detectors, according to some embodiments of the present disclosure. As shown, the graph 300 includes an x-axis 310 corresponding to detector position (e.g., in mm) and a y-axis 320 corresponding to number of counts at each detector position. The position of each detector can correspond to a particular material (e.g., ¹⁰B, ¹¹B, ¹⁸O, ²⁸Si, ²⁹Si, ³⁰Si, ¹⁸O₂, ²⁸Si¹⁶O, ²⁹Si¹⁶O, ²⁸Si¹⁸O, and ³⁰Si¹⁸O).

Referring back to FIG. 2, a recipe can be set up manually with a preset coil current I for species A, B, C and D with the individual detector positions properly centered at X_{A}, X_{B}, X_{C}, and X_{D}, respectively. Because a SIMS system including the mass spectrometer 200 can be used for different applications each having respective mass spectrometer settings, when the same recipe is used again later, the magnetic field 240 can be slightly different from the previous one because of magnetic hysteresis. Consequently, the measured species A, B, C and D can (slightly) miss the detectors (e.g., be off-center). The misalignment can cause a counting error, and thus a measurement error for the species A, B, C and D.

One way to maximize counts is by manually recalibrating the detector positions by moving individual detector positions. However, this process is time-consuming and requires specially trained operators to complete the task, which prevents the ability to implement a fully automated inline SIMS system.

A one-to-one relationship between a given magnetic field 240 and an ion trajectory (e.g., ion path 260) can be recognized. The magnetic field 240 can be restored to the previous one if the same species used in the recipe is centered on the same detector at the same position. When moving the detector to the previous position, the count most likely is off somewhat from the maximal value because of the magnetic hysteresis.

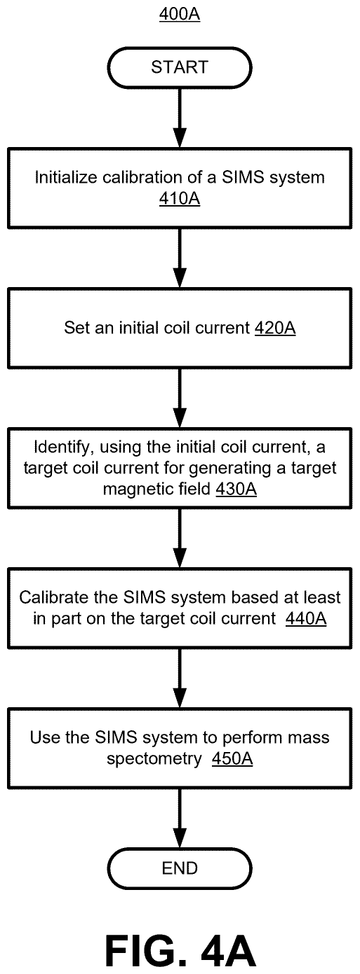

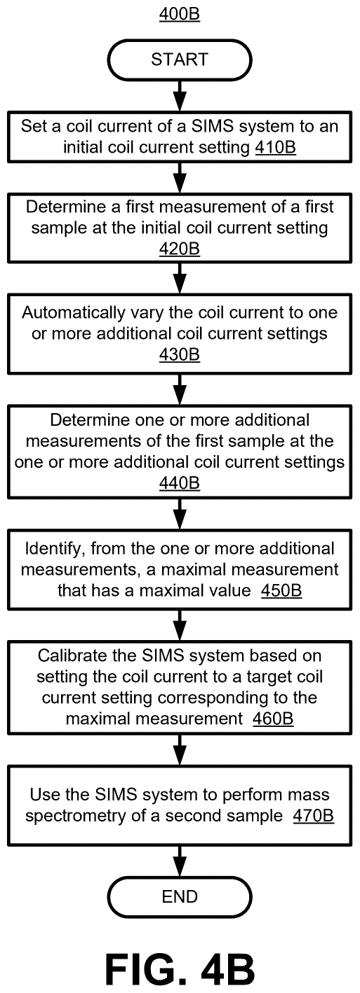

Instead of moving the detector position to maximize the count as described above, an automated calibration method can be used to change the magnitude of the current flowing through the coil 210. More specifically, the current flowing through the coil 210 can be adjusted (e.g., rocked) to maximize the count. The new coil current magnitude Iₘₐₓ can produce a magnetic field 240 that is the same as the previous one because of the one-to-one relationship between the magnetic field 240 and ion trajectories. Since the magnetic field 240 is restored, the detector positions for all species determined in the recipe are valid, and there is no reason to perform additional mass calibrations. Further details regarding implementing an automated calibration method will now be described below with reference to FIGS. 4A-4B.

FIG. 4A is a flow diagram of an example method 400A of implementing automated calibration of a secondary ion mass spectrometry (SIMS) system, in accordance with one embodiment of the present disclosure. Method 400A may be performed by processing logic that can include hardware (circuitry, dedicated logic, etc.), software (e.g., instructions run on a processing device), or a combination thereof. In one implementation, some, or all of the operations of method 400A can be performed by one or more components of system 100 of FIG. 1.

At operation 410A, processing logic initializes calibration of a SIMS system. Initialization calibration of the SIMS system can include at least partially compensating for magnetic hysteresis within a SIMS system. More specifically, at least partially compensating for magnetic hysteresis within a SIMS system can include repeatedly switching magnetic polarity settings of the SIMS system by changing the coil current direction multiple times (e.g., the direction of the current through the coil 210 of FIG. 2). The repeated switching of the magnetic polarity settings can reduce the difference between the actual magnetic field and a target magnetic field, which can reduce the effect of magnetic hysteresis. The target magnetic field is a magnetic field having a target magnitude to be generated by a coil of the SIMS system (e.g., mass spectrometer). However, there may be a residual difference between the actual magnetic field and the target magnetic field.

At operation 420A, processing logic sets an initial coil current. More specifically, the initial coil current can be a previously used coil current having a magnitude that flowed through the coil to generate to a previous magnetic field within the SIM system. The previous magnetic field is a magnetic field having a previous magnitude generated by the coil.

At operation 430A, processing logic identifies, using the initial coil current, a target coil current. The target coil current is for generating the target magnetic field. More specifically, the target coil current is a current that can flow through the coil to generate the target magnetic field. More specifically, identifying the target coil current can include adjusting the initial coil current about a given current range to identify a current resulting in the maximal number of counts detected by a detector of the SIMS system (e.g., without manually adjusting detector position). Because the target magnetic field is very close to the original setting, a less than one percent adjustment in the initial coil current may be sufficient to identify the target coil current as the current resulting in the maximal number of counts detected by the detector. For example, the initial coil current can be identified I₀. The coil current can be adjusted (e.g., rocked) about I₀ to maximize a known peak (e.g., strong peak) near the middle of the range of the mass spectrometer (e.g., by maximizing the counts for a known species). More specifically, I₀ can be adjusted in a range defined by d[I₀−d, I₀+d] to identify a target coil current resulting in a maximal number of counts, Iₘₐₓ. The value of d is chosen to be small (e.g., a less than one percent adjustment in I₀). Since the value of d is small, any magnetic hysteresis associated with adjusting I₀ based on d can be neglected.

At operation 440A, processing logic calibrates the SIMS system based at least in part on the target coil current. The calibration can be performed to remove the residual difference between the actual magnetic field and the target magnetic field. The target coil current, which has been determined to result in the maximal number of counts, is the correct setting to generate the target magnetic field. Since the counts (and thus intensity) are maximized, the effect of the magnetic hysteresis is corrected.

At operation 450A, processing logic uses the SIMS system to perform mass spectrometry after calibrating the SIMS system. Further details regarding operations 410A-450A are described above with reference to FIGS. 1-3 and will now be described below with reference to FIG. 4B.

FIG. 4B is a flow diagram of an example method 400B of implementing automated calibration of a secondary ion mass spectrometry (SIMS) system, in accordance with one embodiment of the present disclosure. Method 400B may be performed by processing logic that can include hardware (circuitry, dedicated logic, etc.), software (e.g., instructions run on a processing device), or a combination thereof. In one implementation, some, or all of the operations of method 400B can be performed by one or more components of system 100 of FIG. 1.

At operation 410B, processing logic sets a coil current of a SIMS system to an initial coil current setting and, at operation 420B, processing logic determines a first measurement of a first sample at the initial coil current setting. The coil current is a current that flows through a coil to generate a magnetic field used to separate secondary ions of sputtered particles ejected from the first sample into respective secondary ion trajectories. For example, the initial coil current setting can correspond to a previous coil current setting that was used to determine a previous measurement of a previous sample having a same sample type as the first sample. The first measurement and the previous measurement can each correspond to a respective number of counts detected by a detector of the SIMS system. In some embodiments, prior to setting the coil current to the initial coil current setting, processing logic at least partially compensates for magnetic hysteresis within the SIMS system (e.g., as described above with reference to FIG. 4A).

At operation 430B, processing logic automatically varies the coil current to one or more additional coil current settings. More specifically, the one or more additional coil current settings have up to a threshold delta from the initial coil current setting. The value of the threshold delta can be chosen to be sufficiently small to neglect magnetic hysteresis associated with automatically varying the coil current from the initial coil current setting (e.g., a less than one percent adjustment in the initial coil current setting).

At operation 440B, processing logic determines one or more additional measurements of the first sample at the one or more additional coil current settings. In some embodiments, each additional measurement corresponds to respective number of counts detected by the detector.

At operation 450B, processing logic identifies, from the one or more additional measurements, a maximal measurement that has a maximal value. For example, the maximal measurement can be the additional measurement that corresponds to the maximal number of counts detected by the detector.

At operation 460B, processing logic calibrates the SIMS system based on setting the coil current to a target coil current setting corresponding to the maximal measurement. The target coil current setting is for generating a target magnetic field. More specifically, the target coil current setting is a setting for a coil current that can flow through the coil to generate the target magnetic field. In some embodiments, the target magnetic field corresponds to a magnetic field caused by the previous coil current setting that was used to determine the prior measurement, and calibrating the SIMS system includes compensating for a residual difference between an actual magnetic field and the target magnetic field.

For example, the initial coil current setting can be represented by I₀. The coil current can be automatically varied about I₀ to maximize a known peak (e.g., strong peak) near the middle of the range of the mass spectrometer (e.g., by maximizing the counts for a known species). More specifically, I₀ can be adjusted in a range defined by a threshold delta d [I₀−d, I₀+d] to identify the maximal measurement (e.g., the maximal number of counts detected by the detector). The value of d can be chosen to be sufficiently small (e.g., a less than one percent adjustment in I₀) to neglect magnetic hysteresis associated with adjusting I₀ based on d. The target coil current setting can be represented by Iₘₐₓ.

At operation 470B, processing logic uses the SIMS system to perform mass spectrometry of a second sample after calibrating the SIMS system. Further details regarding operations 410B-470B are described above with reference to FIGS. 1-4A.

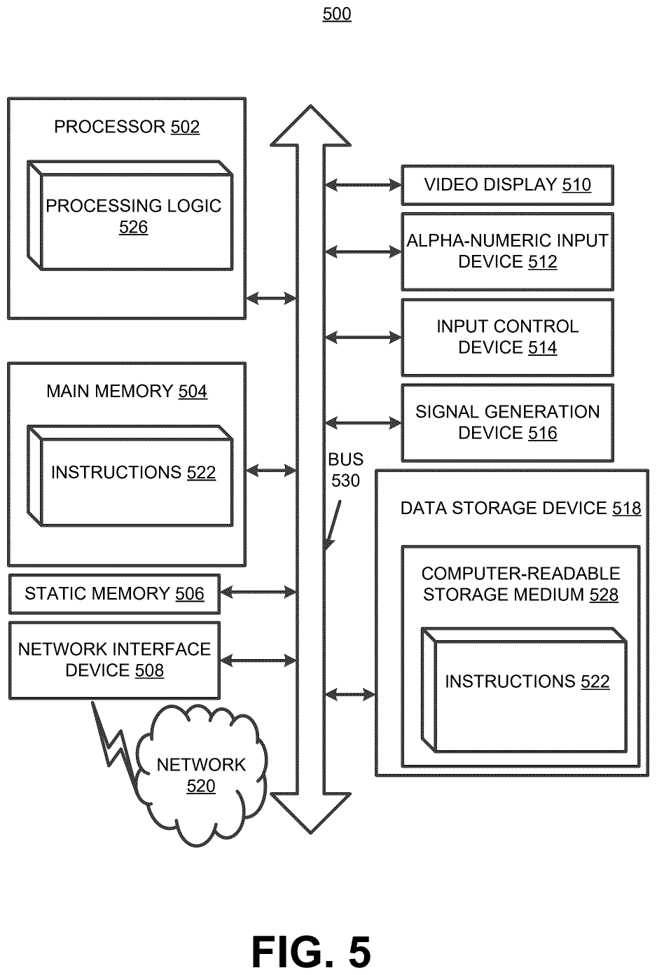

FIG. 5 illustrates an embodiment of a diagrammatic representation of a computing device associated with a substrate manufacturing system, in according to some embodiments of the present disclosure.

In one implementation, FIG. 5 illustrates a processing device 500 that may be a part of any computing device associated with any of the above-described figures, or any combination thereof. Example processing device 500 may be connected to other processing devices in a LAN, an intranet, an extranet, and/or the Internet. The processing device 500 may be a personal computer (PC), a set-top box (STB), a server, a network router, switch or bridge, or any device capable of executing a set of instructions (sequential or otherwise) that specify actions to be taken by that device. Further, while a single example processing device is illustrated, the term “processing device” shall also be taken to include any collection of processing devices (e.g., computers) that individually or jointly execute a set (or multiple sets) of instructions to perform any one or more of the methods discussed herein.

Example processing device 500 may include a processor 502 (e.g., a CPU), a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory (e.g., a data storage device 518), which may communicate with each other via a bus 530.

Processor 502 represents one or more general-purpose processing devices such as a microprocessor, central processing unit, or the like. More particularly, processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. In accordance with one or more aspects of the present disclosure, processor 502 may be configured to execute instructions (e.g. instructions 522 may include a computing subsystem as seen at least in within the controller of FIG. 1). In embodiments, instructions 522 include instructions for a performing the methods of FIGS. 4A-4B.

Example processing device 500 may further comprise a network interface device 508, which may be communicatively coupled to a network 520. Example processing device 500 may further comprise a video display 510 (e.g., a liquid crystal display (LCD), a touch screen, or a cathode ray tube (CRT)), an alphanumeric input device 512 (e.g., a keyboard), an input control device 514 (e.g., a cursor control device, a touch-screen control device, a mouse), and a signal generation device 516 (e.g., an acoustic speaker).

Data storage device 518 may include a computer-readable storage medium (or, more specifically, a non-transitory computer-readable storage medium) 528 on which is stored one or more sets of executable instructions 522. In accordance with one or more aspects of the present disclosure, executable instructions 522 may comprise executable instructions.

Executable instructions 522 may also reside, completely or at least partially, within main memory 504 and/or within processor 502 during execution thereof by example processing device 500, main memory 504 and processor 502 also constituting computer-readable storage media. Executable instructions 522 may further be transmitted or received over a network via network interface device 508.

While the computer-readable storage medium 528 is shown in FIG. 5 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

It should be understood that the above description is intended to be illustrative, and not restrictive. Many other embodiment examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

The embodiments of methods, hardware, software, firmware or code set forth above may be implemented via instructions or code stored on a machine-accessible, machine readable, computer accessible, or computer readable medium which are executable by a processing element. “Memory” includes any mechanism that provides (i.e., stores and/or transmits) information in a form readable by a machine, such as a computer or electronic system. For example, “memory” includes random-access memory (RAM), such as static RAM (SRAM) or dynamic RAM (DRAM); ROM; magnetic or optical storage medium; flash memory devices; electrical storage devices; optical storage devices; acoustical storage devices, and any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment, embodiment, and/or other exemplarily language does not necessarily refer to the same embodiment or the same example, but may refer to different and distinct embodiments, as well as potentially the same embodiment.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such. Also, the terms “first,” “second,” “third,” “fourth,” etc. as used herein are meant as labels to distinguish among different elements and may not necessarily have an ordinal meaning according to their numerical designation.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. The essential elements of a digital computer a central processing unit for performing or executing instructions and one or more memory devices for storing instructions and digital data. The central processing unit and the memory can be supplemented by, or incorporated in, special purpose logic circuitry or quantum simulators. Generally, a digital computer will also include, or be operatively coupled to receive digital data from or transfer digital data to, or both, one or more mass storage devices for storing digital data, e.g., magnetic, magneto-optical disks, optical disks, or systems suitable for storing information. However, a digital computer need not have such devices.

Digital computer-readable media suitable for storing digital computer program instructions and digital data include all forms of non-volatile digital memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks.

Control of the various systems described in this specification, or portions of them, can be implemented in a digital computer program product that includes instructions that are stored on one or more non-transitory machine-readable storage media, and that are executable on one or more digital processing devices. The systems described in this specification, or portions of them, can each be implemented as an apparatus, method, or system that may include one or more digital processing devices and memory to store executable instructions to perform the operations described in this specification.

While this specification contains many specific embodiment details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily rely on the particular order shown, or sequential order, to achieve desirable results. In some cases, multitasking and parallel processing may be advantageous.

What is claimed is:

1. A method comprising:
setting a coil current of a secondary ion mass spectrometry (SIMS) system to an initial coil current setting;
determining a first measurement of a first sample at the initial coil current setting;
automatically varying the coil current to one or more additional coil current settings that have up to a threshold delta from the initial coil current setting;
determining one or more additional measurements of the first sample at the one or more additional coil current settings;
identifying, from the one or more additional measurements, a maximal measurement that has a maximal value; and
calibrating the SIMS system based on setting the coil current to a target coil current setting corresponding to the maximal measurement.

2. The method of claim 1, further comprising, prior to setting the coil current to the initial coil current setting, repeatedly switching magnetic polarity settings of the SIMS system to reduce magnetic hysteresis.

3. The method of claim 1, further comprising, after calibrating the SIMS system, using the SIMS system to perform mass spectrometry of a second sample.

4. The method of claim 3, wherein the initial coil current setting corresponds to a previous coil current setting that was used to determine a previous measurement of a previous sample having a same sample type as the first sample.

5. The method of claim 4, wherein calibrating the SIMS system comprises compensating for a residual difference between an actual magnetic field and a target magnetic field, and wherein the target magnetic field corresponds to a magnetic field caused by the previous coil current setting that was used to determine the previous measurement.

6. The method of claim 1, wherein the first measurement and the one or more additional measurements each correspond to a respective number of counts detected by a detector of the SIMS system.

7. A method comprising:
initializing calibration of a secondary ion mass spectrometry (SIMS) system;
setting an initial coil current;
identifying, using the initial coil current, a target coil current for generating a target magnetic field; and
calibrating the SIMS system based at least in part on the target coil current.

8. The method of claim 7, further comprising using the SIMS system to perform mass spectrometry after calibrating the SIMS system.

9. The method of claim 7, wherein initializing the calibration of the SIMS system comprises at least partially compensating for magnetic hysteresis within the SIMS system.

10. The method of claim 9, wherein at least partially compensation for the magnetic hysteresis within the SIMS system comprises repeatedly switch magnetic polarity settings of the SIMS system.

11. The method of claim 10, wherein calibrating the SIMS system comprises compensating for a residual difference between an actual magnetic field and the target magnetic field resulting from repeatedly switching the magnetic polarity settings.

12. The method of claim 7, wherein the target coil current corresponds to a current resulting in a maximal number of counts detected by a detector of the SIMS system.

13. The method of claim 12, wherein identifying the target coil current comprises adjusting the initial coil current about a current range to identify the current resulting in the maximal number of counts.

14. A system comprising:
a memory; and
a processing device, operatively coupled with a memory, to:
initialize calibration of a secondary ion mass spectrometry (SIMS) system;
set an initial coil current;
identify, using the initial coil current, a target coil current for generating a target magnetic field; and
calibrate the SIMS system based at least in part on the target coil current.

15. The system of claim 14, wherein the processing device is further to use the SIMS system to perform mass spectrometry after calibrating the SIMS system.

16. The system of claim 14, wherein, to initialize the calibration of the SIMS system, the processing device is to compensate for magnetic hysteresis within the SIMS system by repeatedly switch magnetic polarity settings of the SIMS system.

17. The system of claim 16, wherein, to calibrate the SIMS system, the processing device is to compensate for a residual difference between an actual magnetic field and the target magnetic field resulting from repeatedly switching the magnetic polarity settings.

18. The system of claim 14, wherein the target coil current corresponds to a current resulting in a maximal number of counts detected by a detector of a plurality of detectors of the SIMS system.

19. The system of claim 18, wherein, to identify the target coil current, the processing device is to adjust the initial coil current about a current range to identify the current resulting in the maximal number of counts.

20. The system of claim 14, further comprising the SIMS system, wherein the SIMS system comprises:
an ion source to generate a sputter beam comprising primary ions;
a magnetic sector to separate secondary ions of sputtered particles from a sample into a plurality of ion trajectories, the magnetic sector comprising a coil to generate the target magnetic field using the target coil current; and
a plurality of detectors, each detector of the plurality of detectors to receive ions of a respective ion trajectory of the plurality of ion trajectories.
